(19) United States
(12) Patent Application Publication
(10) Pub. No.: US 2009/0251440 A1
(43) Pub. Date: Oct. 8, 2009

(54) Audio Bookmarking

(75) Inventors: Tracy L. Edgecomb, Berkeley, CA (US); Jim Marggraff, Lafayette, CA (US); Alexander Sasha Pesic, San Ramon, CA (US)

Correspondence Address: FENWICK & WEST LLP, SILICON VALLEY CENTER, 801 CALIFORNIA STREET, MOUNTAIN VIEW, CA, 94041, US

(73) Assignee: LIVESCRIBE, INC., Oakland, CA (US)

(21) Appl. No.: 12/415,226

(22) Filed: Mar. 31, 2009

Related U.S. Application Data
(60) Provisional application No. 61/042,130, filed on Apr. 3, 2008.

(51) Int. Cl. G06F 3/033; G06F 17/00

(52) U.S. Cl. 345/179; 700/94; 715/863

(57) ABSTRACT

A system and method for identifying temporal positions in audio data and accessing the identified temporal positions are disclosed. “Audio bookmarks” are created by using various types of input, such as accessing a printed control with a smart pen, providing a voice command to the smart pen or providing a written command to the smart pen to identify temporal positions within the audio data. Alternatively, one or more rules are applied to audio data by a pen-based computing system to identify temporal positions in the audio data. The audio bookmarks are associated with one or more visual, auditory or tactile indicators showing the location of the audio bookmarks in the audio data. When an indicator is accessed, a portion of the audio data is played beginning from the temporal position associated with the accessed indicator. Additional data, such as written data, may also be associated with an indicator.

### CROSS REFERENCE TO RELATED APPLICATIONS

This application claims the benefit of U.S. Provisional Application No. 61/042,130, filed Apr. 3, 2008, which is incorporated by reference in its entirety.

### BACKGROUND

This invention relates generally to pen-based computing systems, and more particularly to organizing audio data captured by a pen-based computing system.

As audio recording device size has decreased while recording quality has increased, it has become more convenient to capture audio data from various events such as meetings or lectures. Additionally, storage device capacity has significantly increased, simplifying storage of captured audio for later review.

However, because audio data is inherently non-visual, it is difficult to scan or browse, making it difficult for users to quickly access a specific part of stored audio data for review. This difficulty in navigating through stored audio data increases the time needed for a user to locate a particular segment of the stored audio data, often requiring users to repeatedly fast forward and rewind through the stored audio data. The non-visual nature of audio data also it difficult to apply conventional methods for organizing visual or text data (e.g., indices, page numbering, bookmarking, color coding) to stored audio data. Accordingly, there is a need for a system and method for organizing stored audio data to facilitate later access to portions of the stored audio data.

### SUMMARY

Embodiments of the invention present a system and method for allowing access to identified positions within audio data. A user identifies one or more positions within the audio data, creating “audio bookmarks” associated with the audio data, using various types of input, such as accessing a printed control with a smart pen, providing a voice command to the smart pen or providing a written command to the smart pen. Alternatively, one or more rules are applied to audio data by a pen-based computing system to automatically identify temporal positions within the audio data.

In one embodiment, the identified temporal positions, or audio bookmarks, are associated with one or more visual, auditory or tactile indicators that are communicated to the user. The indicators show the location and frequency of the audio bookmarks associated with the audio data, showing their temporal positions in the audio data. Responsive to the user accessing one of the indicators, a portion of the audio data is played beginning from the temporal position associated with the accessed indicator. In an embodiment, additional data, such as written data, is associated with an indicator, so that accessing the indicator causes presentation of both the written data and audio data to the user.

### BRIEF DESCRIPTION OF THE DRAWINGS

FIG. 1 is a schematic diagram of a pen-based computing system, in accordance with an embodiment of the invention.

FIG. 2 is a diagram of a smart pen for use in the pen-based computing system, in accordance with an embodiment of the invention.

FIG. 3 is a flow chart of a method for generating audio bookmarks with a pen-based computing system in accordance with an embodiment of the invention.

FIG. 4 is a diagram of a pen-based computing system for generating audio bookmarks in accordance with an embodiment of the invention.

FIG. 5 is a diagram of navigation buttons and control buttons for navigating between audio bookmarks in accordance with an embodiment of the invention.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Pen-Based Computing System

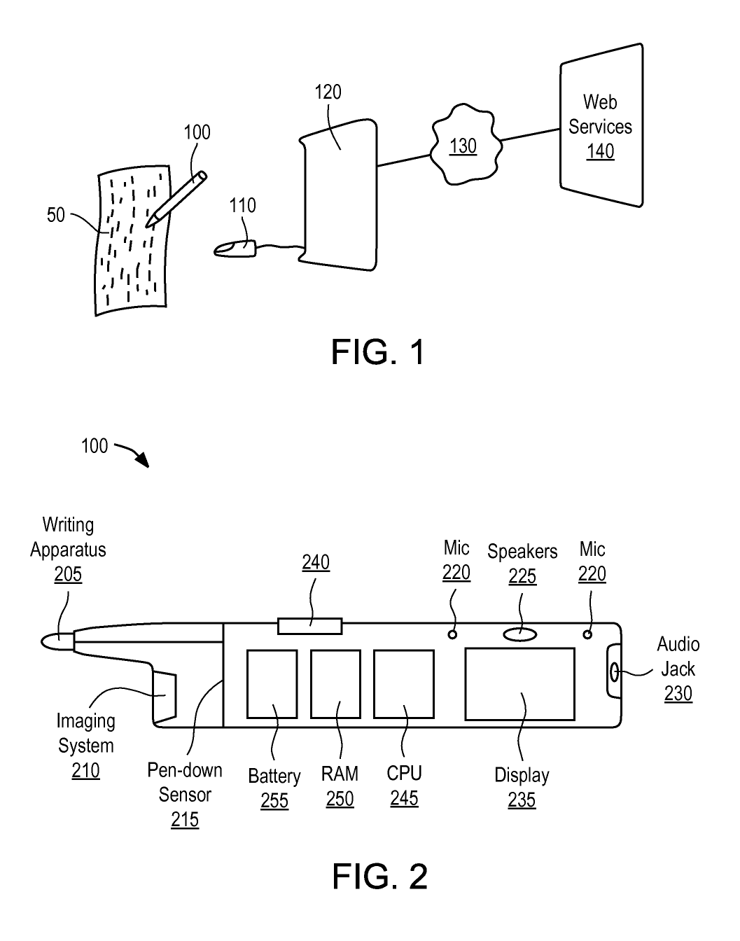

Embodiments of the invention may be implemented on various embodiments of a pen-based computing system, an example of which is illustrated in FIG. 1. In this embodiment, the pen-based computing system comprises a writing surface 50, a smart pen 100, a docking station 110, a client system 120, a network 130, and a web services system 140. The smart pen 100 includes onboard processing capabilities as well as input/output functionalities, allowing the pen-based computing system to expand the screen-based interactions of traditional computing systems to other surfaces on which a user can write. For example, the smart pen 100 may be used to capture electronic representations of writing as well as record audio during the writing, and the smart pen 100 may also be capable of outputting visual and audio information back to the user. With appropriate software on the smart pen 100 for various applications, the pen-based computing system thus provides a new platform for users to interact with software programs and computing services in both the electronic and paper domains, including electronic paper.

In the pen based computing system, the smart pen 100 provides input and output capabilities for the computing system and performs some or all of the computing functionalities of the system. Hence, the smart pen 100 enables user interaction with the pen-based computing system using multiple modalities. In one embodiment, the smart pen 100 receives input from a user, using multiple modalities, such as capturing a user's writing or other hand gesture or recording audio, and provides output to a user using various modalities, such as displaying visual information, playing audio or responding in context to physical interaction such as tapping, tracing, or selecting other pre-existing visual information. In other embodiments, the smart pen 100 includes additional input modalities, such as motion sensing or gesture capture, and/or additional output modalities, such as vibrational feedback. By receiving different types of input, the smart pen 100 may simultaneously capture different types of data, such as audio, movement and/or written or text, which can be used to generate a session including different types of data.

The components of a particular embodiment of the smart pen 100 are shown in FIG. 2 and described in more detail in the accompanying text. The smart pen 100 preferably has a form factor that is substantially shaped like a pen or other writing implement, although certain variations on the general shape may exist to accommodate other functions of the pen, or may even be an interactive multi-modal non-writing implement. For example, the smart pen 100 may be slightly thicker than a standard pen so that it can contain additional components, or the smart pen 100 may have additional structural features (e.g., a flat display screen) in addition to the structural features that form the pen shaped form factor. Additionally, the smart pen 100 may also include any mechanism by which a user can provide input or commands to the smart pen computing system or may include any mechanism by which a user can receive or otherwise observe information from the smart pen computing system. For example a variety of types of switches including buttons, rocker panels, capacitive sensors, heat sensors, pressure sensors, biometric sensors or other sensing devices could be added.

The smart pen 100 is designed to work in conjunction with the writing surface 50 so that the smart pen 100 can capture writing that is made on the writing surface 50. In one embodiment, the writing surface 50 comprises a sheet of paper (or any other suitable material that can be written upon) and is encoded with a pattern that can be read by the smart pen 100. An example of such a writing surface 50 is the so-called “dot-enabled paper” available from Anoto Group AB of Sweden (local subsidiary Anoto, Inc. of Waltham, Mass.), and described in U.S. Pat. No. 7,175,095, incorporated by reference herein. This dot-enabled paper has a pattern of dots encoded on the paper. A smart pen 100 designed to work with this dot enabled paper includes an imaging system and a processor that can determine the position of the smart pen's writing tip with respect to the encoded dot pattern. This position of the smart pen 100 may be referred to using coordinates in a predefined “dot space,” and the coordinates can be either local (i.e., a location within a page of the writing surface 50) or absolute (i.e., a unique location across multiple pages of the writing surface 50).

In other embodiments, the writing surface 50 may be implemented using mechanisms other than encoded paper to allow the smart pen 100 to capture gestures and other written input. For example, the writing surface may comprise a tablet or other electronic medium that senses writing made by the smart pen 100. In another embodiment, the writing surface 50 comprises electronic paper, or e-paper. This sensing may be performed entirely by the writing surface 50, entirely by the smart pen 100, or in conjunction with the smart pen 100. Even if the role of the writing surface 50 is only passive (as in the case of encoded paper), it can be appreciated that the design of the smart pen 100 will typically depend on the type of writing surface 50 for which the pen based computing system is designed. Moreover, written content may be displayed on the writing surface 50 mechanically (e.g., depositing ink on paper using the smart pen 100), electronically (e.g., displayed on the writing surface 50), or not at all (e.g., merely saved in a memory). In another embodiment, the smart pen 100 is equipped with sensors to sense movement of the smart pen 100 tip, thereby sensing writing gestures without requiring a writing surface 50 at all. Any of these technologies may be used in a gesture capture system incorporated in the smart pen 100.

In various embodiments, the smart pen 100 can communicate with a general purpose computing system 120, such as a personal computer, for various useful applications of the pen based computing system. For example, content captured by the smart pen 100 may be transferred to the computing system 120 for further use by that system 120. For example, the computing system 120 may include management software that allows a user to store, access, review, delete, and otherwise manage the information acquired by the smart pen 100. Downloading acquired data from the smart pen 100 to the computing system 120 also frees the resources of the smart pen 100 so that it can acquire more data. Conversely, content may also be transferred back onto the smart pen 100 from the computing system 120. In addition to data, the content provided by the computing system 120 to the smart pen 100 may include software applications that can be executed by the smart pen 100.

The smart pen 100 may communicate with the computing system 120 via any of a number of known communication mechanisms, including both wired and wireless communications, such as Bluetooth, WiFi, RF, infrared and ultrasonic sound. In one embodiment, the pen based computing system includes a docking station 110 coupled to the computing system. The docking station 110 is mechanically and electrically configured to receive the smart pen 100, and when the smart pen 100 is docked the docking station 110 may enable electronic communications between the computing system 120 and the smart pen 100. The docking station 110 may also provide electrical power to recharge a battery in the smart pen 100.

FIG. 2 illustrates an embodiment of the smart pen 100 for use in a pen based computing system, such as the embodiments described above. In the embodiment shown in FIG. 2, the smart pen 100 comprises a marker 205, an imaging system 210, a pen down sensor 215, one or more microphones 220, a speaker 225, an audio jack 230, a display 235, an I/O port 240, a processor 245, an onboard memory 250, and a battery 255. It should be understood, however, that not all of the above components are required for the smart pen 100, and this is not an exhaustive list of components for all embodiments of the smart pen 100 or of all possible variations of the above components. For example, the smart pen 100 may also employ buttons, such as a power button or an audio recording button and/or status indicator lights. Moreover, as used herein in the specification and in the claims, the term “smart pen” does not imply that the pen device has any particular feature or functionality described herein for a particular embodiment, other than those features expressly recited. A smart pen may have any combination of fewer than all of the capabilities and subsystems described herein.

The marker 205 enables the smart pen to be used as a traditional writing apparatus for writing on any suitable surface. The marker 205 may thus comprise any suitable marking mechanism, including any ink-based or graphite-based marking devices or any other devices that can be used for writing. In one embodiment, the marker 205 comprises a replaceable ballpoint pen element. The marker 205 is coupled to a pen down sensor 215, such as a pressure sensitive element. The pen down sensor 215 thus produces an output when the marker 205 is pressed against a surface, thereby indicating when the smart pen 100 is being used to write on a surface.

The imaging system 210 comprises sufficient optics and sensors for imaging an area of a surface near the marker 205. The imaging system 210 may be used to capture handwriting and/or gestures made with the smart pen 100. For example, the imaging system 210 may include an infrared light source that illuminates a writing surface 50 in the general vicinity of the marker 205, where the writing surface 50 includes an encoded pattern. By processing the image of the encoded pattern, the smart pen 100 can determine where the marker 205 is in relation to the writing surface 50. An imaging array of the imaging system 210 then images the surface near the marker 205 and captures a portion of a coded pattern in its field of view. Thus, the imaging system 210 allows the smart pen 100 to receive data using at least one input modality, such as receiving written input. The imaging system 210 incorporating optics and electronics for viewing a portion of the writing surface 50 is just one type of gesture capture system that can be incorporated in the smart pen 100 for electronically capturing any writing gestures made using the pen, and other embodiments of the smart pen 100 may use other appropriate means for achieving the same function. In an embodiment, data captured by the imaging system 210 is subsequently processed, allowing one or more content recognition algorithms, such as character recognition, to be applied to the received data.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 50 (e.g., and not written using the smart pen 100). The imaging system 210 may further be used in combination with the pen down sensor 215 to determine when the marker 205 is touching the writing surface 50. As the marker 205 is moved over the surface, the pattern captured by the imaging array changes, and the user's handwriting can thus be determined and captured by a gesture capture system (e.g., the imaging system 210 in FIG. 2) in the smart pen 100. This technique may also be used to capture gestures, such as when a user taps the marker 205 on a particular location of the writing surface 50, allowing data capture using another input modality of motion sensing or gesture capture.

The imaging system 210 may further be used in combination with the pen down sensor 215 to determine when the marker 205 is touching the writing surface 50. As the marker 205 is moved over the surface, the pattern captured by the imaging array changes, and the user's handwriting can thus be determined and captured by the smart pen 100. This technique may also be used to capture gestures, such as when a user taps the marker 205 on a particular location of the writing surface 50, allowing data capture using another input modality of motion sensing or gesture capture.

Another data capture device on the smart pen 100 are the one or more microphones 220, which allow the smart pen 100 to receive data using another input modality, audio capture. The microphones 220 may be used for recording audio, which may be synchronized to the handwriting capture described above. In an embodiment, the one or more microphones 220 are coupled to signal processing software executed by the processor 245, or by a signal processor (not shown), which removes noise created as the marker 205 moves across a writing surface and/or noise created as the smart pen 100 touches down to or lifts away from the writing surface. In an embodiment, the processor 245 synchronizes captured written data with captured audio data. For example, a conversation in a meeting may be recorded using the microphones 220 while a user is taking notes that are also being captured by the smart pen 100. Synchronizing recorded audio and captured handwriting allows the smart pen 100 to provide a coordinated response to a user request for previously captured data. For example, responsive to a user request, such as a written command, parameters for a command, a gesture with the smart pen 100, a spoken command or a combination of written and spoken commands, the smart pen 100 provides both audio output and visual output to the user. The smart pen 100 may also provide haptic feedback to the user.

The speaker 225, audio jack 230, and display 235 provide outputs to the user of the smart pen 100 allowing presentation of data to the user via one or more output modalities. The audio jack 230 may be coupled to earphones so that a user may listen to the audio output without disturbing those around the user, unlike with a speaker 225. Earphones may also allow a user to hear the audio output in stereo or full three-dimensional audio that is enhanced with spatial characteristics. Hence, the speaker 225 and audio jack 230 allow a user to receive data from the smart pen using a first type of output modality by listening to audio played by the speaker 225 or the audio jack 230.

The display 235 may comprise any suitable display system for providing visual feedback, such as an organic light emitting diode (OLED) display, allowing the smart pen 100 to provide output using a second output modality by visually displaying information. In use, the smart pen 100 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 100, and the display 235 may display word phrases, static or dynamic images, or prompts as directed by such an application. In addition, the speaker 225 and audio jack 230 may also be used to play back audio data that has been recorded using the microphones 220.

The input/output (I/O) port 240 allows communication between the smart pen 100 and a computing system 120, as described above. In one embodiment, the I/O port 240 comprises electrical contacts that correspond to electrical contacts on the docking station 110, thus making an electrical connection for data transfer when the smart pen 100 is placed in the docking station 110. In another embodiment, the I/O port 240 simply comprises ajack for receiving a data cable (e.g., Mini-USB or Micro-USB). Alternatively, the I/O port 240 may be replaced by a wireless communication circuit in the smart pen 100 to allow wireless communication with the computing system 120 (e.g., via Bluetooth, WiFi, infrared, or ultrasonic).

A processor 245, onboard memory 250, and battery 255 (or any other suitable power source) enable computing functionalities to be performed at least in part on the smart pen 100. The processor 245 is coupled to the input and output devices and other components described above, thereby enabling applications running on the smart pen 100 to use those components. In one embodiment, the processor 245 comprises an ARM9 processor, and the onboard memory 250 comprises a small amount of random access memory (RAM) and a larger amount of flash or other persistent memory. As a result, executable applications can be stored and executed on the smart pen 100, and recorded audio and handwriting can be stored on the smart pen 100, either indefinitely or until offloaded from the smart pen 100 to a computing system 120. For example, the smart pen 100 may locally stores one or more content recognition algorithms, such as character recognition or voice recognition, allowing the smart pen 100 to locally identify input from one or more input modality received by the smart pen 100.

In an embodiment, the smart pen 100 also includes an operating system or other software supporting one or more input modalities, such as handwriting capture, audio capture or gesture capture, or output modalities, such as audio playback or display of visual data. The operating system or other software may support a combination of input modalities and output modalities and manages the combination, sequencing and transitioning between input modalities (e.g., capturing written and/or spoken data as input) and output modalities (e.g., presenting audio or visual data as output to a user). For example, this transitioning between input modality and output modality allows a user to simultaneously write on paper or another surface while listening to audio played by the smart pen 100, or the smart pen 100 may capture audio spoken from the user while the user is also writing with the smart pen 100.

In an embodiment, the operating system and applications support a sequence of independent and/or concurrent input and output modalities and seamless transitions between these modalities to provide for language learning. For example, a language learning (LL) application running on an operating system supporting modality independence, concurrence and sequencing might begin a lesson announcing that today is a lesson in writing, reading, speaking and listening to Chinese. The smart pen 100 might then animate the creation of a Mandarin character, drawing strokes of the character in proper order on the display 235, while simultaneously announcing the character's pronunciation via the speaker 225. The operating system would enable the simultaneous display and synchronized delivery of audio. The LL application might then prompt the user to draw each stroke of the character, following the animated display of each stroke on the display 225, thus sequencing the transition between modalities of visual output of information displayed on the smart pen 100, in a synchronized manner, with the input of stroke data by a user. As the user becomes more fluent with the creations of the character, and begins writing more rapidly, perhaps writing ahead of the strokes displayed, the OS will enable real time capture and interpretation of strokes and respond with proper displaying and audio as appropriate, engaging the user in a multimodal dialogue. As the user demonstrates proficiency in writing, and the smart pen 100 begins to be lead by the user, displaying strokes in response, rather than leading with strokes, the smart pen 100 might verbally compliment the user and request the user to speak the sound for the character during or after the stroke writing. As the user speaks the character sound, the smart pen 100 could record the sound and compare it to an exemplar. The smart pen 100 might then prompt the user by playing back the exemplar pronunciation and the user pronunciation, providing commentary and/or visual guidance regarding correctness in pronunciation The smart pen 100 might then prompt the user to listen, write, and speak, announcing a series of words one by one, waiting for the user to write and speak the words, while comparing the input speech and writing to exemplars, and redirecting the user to repeat writing or speaking as necessary.

In an extension of this example, the smart pen 100 might prompt the user to interact with a pre-printed Language Learning text or workbook. The smart pen 100 might move the user's attention among multiple displays, from text, to the workbook, to a user's notebook, while continuing a dialogue involving the smart pen 100 speaking and displaying independently or concurrently, directing the user to speak, write, and look at information independently or concurrently. Various other combinations of input modalities and output modalities, and sequencing, are also possible.

In an embodiment, the processor 245 and onboard memory 250 include one or more executable applications supporting and enabling a menu structure and navigation through a file system or application menu, allowing launch of an application or of a functionality of an application. For example, navigation between menu items comprises a dialogue between the user and the smart pen 100 involving spoken and/or written commands and/or gestures by the user and audio and/or visual feedback from the smart pen computing system. Hence, the smart pen 100 may receive input to navigate the menu structure from a variety of modalities.

For example, a writing gesture, a spoken keyword or a physical motion, may indicate that subsequent input is associated with one or more application commands. Input with a spatial and/or temporal component may also be used to indicate that subsequent data. Examples of input with a spatial input include two dots side-by-side. Examples of input with a temporal component include two dots written one immediately after the other. For example, a user may depress the smart pen 100 against a surface twice in rapid succession then write a word or phrase, such as “solve,” “send,” “translate,” “email,” “voice-email” or another predefined word or phrase to invoke a command associated with the written word or phrase or receive additional parameters associated with the command associated with the predefined word or phrase. Because these “quick-launch” commands can be provided in different formats, navigation of a menu or launching of an application is simplified. The “quick-launch” command or commands are preferably easily distinguishable during conventional writing and/or speech.

Alternatively, the smart pen 100 also includes a physical controller, such as a small joystick, a slide control, a rocker panel, a capacitive (or other non-mechanical) surface or other input mechanism which receives input for navigating a menu of applications or application commands executed by the smart pen 100.

### Generating Audio Bookmarks

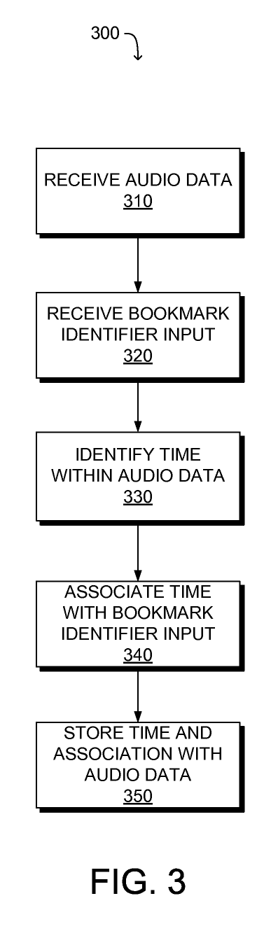

FIG. 3 is a flow chart of a method 300 for generating audio bookmarks with a pen-based computing system in accordance with an embodiment of the invention. Those of skill in the art will recognize that other embodiments can perform the steps of FIG. 3 in different orders. Moreover, other embodiments can include different and/or additional steps than the ones described here. In an embodiment, steps depicted in the method 300 shown in FIG. 3 are implemented by instructions for performing the described actions are embodied or stored within a computer readable medium, e.g., onboard memory 250, that are executable by a processor 245. Those of skill in the art will recognize that the steps of the method 300 may be implemented in embodiments of hardware and/or software or combinations thereof. Moreover, other embodiments can include different and/or additional states or state transitions than the ones shown in FIG. 3.

The smart pen 100 includes an audio input device, such as one or more microphones 220 or other device which receives 310 audio data. In one embodiment, a temporal position in the audio data is identified responsive to the microphones 220, or other audio input device, receiving 320 acoustic input from a user. For example, as the microphones 220 are recording audio data, a user says a predetermined word or phrase, such as “bookmark.” Alternatively, the temporal position in the audio data is identified responsive to the smart pen 100 receiving 320 a predetermined symbol or word via the gesture capture system included in the smart pen 100. For example, the input identifying the temporal position in the audio data is received 320 when the user draws a predetermined symbol, such as an asterisk, or prints a predetermined phrase, such as “bookmark.” In an embodiment, the input identifying the temporal position in the audio data is received 320 when the user accesses or selects one or more specified regions of a writing surface 50.

After receiving 320 the predetermined word or phrase via the microphones 220, the predetermined symbol, word or gesture through the imaging system 210, or other audio bookmark identifier the smart pen 100 identifies 330 the temporal location in the audio data when the predetermined word or phrase, or other audio bookmark identifier, was received 320. This temporal location is associated 340 with the audio data and stored 350, allowing subsequent access to the audio data to access the audio data starting at the temporal location in the audio data by accessing the audio bookmark.

In an embodiment, additional content, such as written notes or other handwriting data, are also associated with an audio bookmark, allowing retrieval of the written content and audio data when an audio bookmark is accessed. Hence, the audio bookmark allows a user to access a specific temporal location in the audio data and also to access additional content, such as written notes or other data, related to the specific temporal location in the audio data. The additional content may be generated in many ways, such as entering notes into a computing system 120 or writing with the smart pen 100 as the audio data is captured by the microphones 210 included in the smart pen 100 or writing with the smart pen 100 while the audio data is being played back to a user. For example, during a paper replay session written data is captured along with audio data and the written data is associated with audio data captured at the time when the written data was captured. The paper replay session allows the captured audio to be played for a user via speakers 225 on the smart pen 100 or other audio output device. Additionally, a user may generate an audio bookmark identifying a temporal location in the captured audio data by tapping a pre-printed control on a page of dot-enabled paper. An additional interaction with the writing surface, such as the dot-enabled paper, may be used to select an audio bookmark and play the captured audio associated with the audio bookmark via speakers 225 on the smart pen 100 or another audio output device. For example, tapping the smart pen 100 on a symbol or word within the written data causes audio data captured at the time the tapped symbol or word was captured to be played through the speakers 225.

After the paper replay session is transferred to the computing device 120, the user may select an audio bookmark by, for example, clicking on a button or providing another suitable form of input to the computing device 120. Alternatively, the user selects an audio bookmarking using the smart pen 100 by accessing a portion of the writing surface 50, such as a written word or symbol or a control area. The smart pen then communicates the audio bookmark selection to the computing device 120. The audio data then jumps to the temporal location associated with the selected audio bookmark, begins playing the audio data starting at the time associated with the selected bookmark and may also display additional content, such as a user's written notes, associated with the temporal location in the audio data associated with the audio bookmark. In an embodiment, the user can also add additional content for association with an audio bookmark. For example, the user can return to the dot-enabled paper including handwritten notes associated with audio data, tap on the handwritten notes to begin playing back the audio data and select an audio bookmark by, for example, tapping a pre-printed control on the dot-enabled paper and write additional notes which are then associated with the selected audio bookmark. After transferring the additional notes to a computing system 120, the additional notes are displayed to the user, in addition to the original notes, when the user selects the audio bookmark associated with the additional notes. Other data, such as metadata describing the sequencing of the written notes or other content, page numbers associated with the written notes or other content or the position of the written content within a page can be stored and associated with the written data, further increasing the amount of data available to the user from the audio bookmark. Additionally, a user may use the computing system 120 to generate additional data associated with an audio bookmark, for example by typing notes or other comments associated with the audio bookmark using the computer system 120.

While FIG. 3 describes generation of audio bookmarks when audio data is being captured, audio bookmarks may also be generated when previously captured audio data is being replayed. When audio data is being replayed, the audio bookmark identifies the temporal position of the audio being played predetermined word or phrase is received 320.

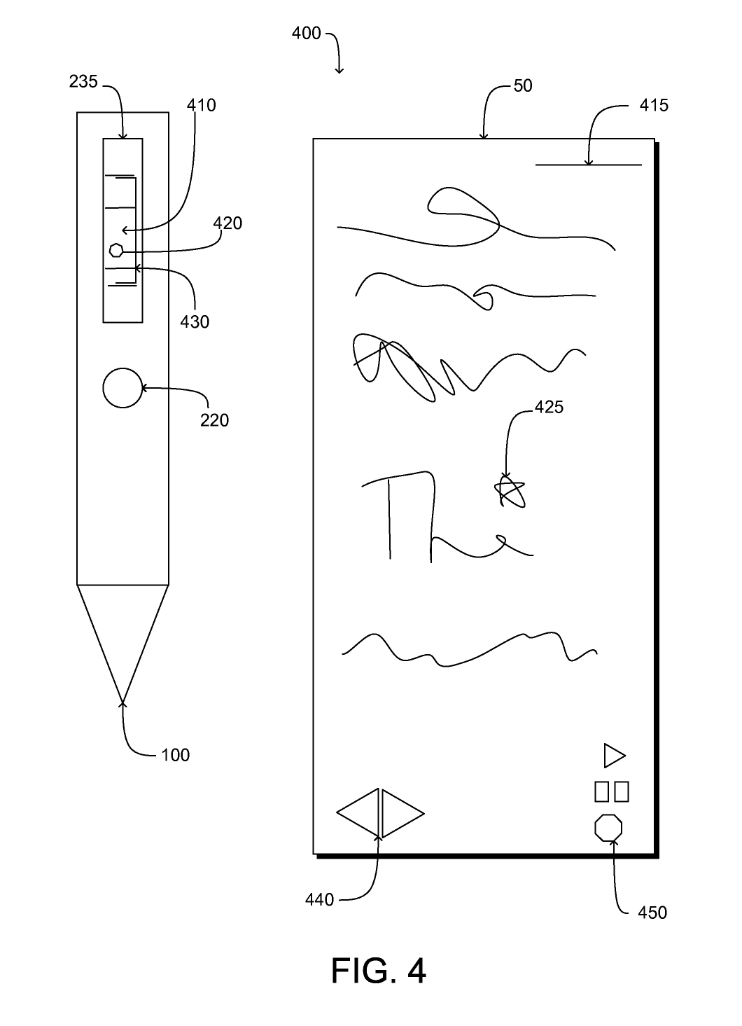

FIG. 4 is a diagram of a pen-based computing system 400 for generating audio bookmarks in accordance with an embodiment of the invention. In the embodiment shown in FIG. 4, the system 400 includes a smart pen 100 and a writing surface 50, such as one or more sheets of dot-enabled paper. However, in other embodiments, the system 400 includes additional and/or different components.

In an embodiment, audio bookmarks are generated responsive to interaction between the smart pen 100 and the writing surface 50, such as a sheet of dot-enabled paper. For example, responsive to a user drawing a predefined bookmark identification symbol 425, such as a star, on the writing surface 50, the smart pen 100 identifies a temporal position in the audio data captured by the one or more microphones 220 corresponding to the time when the predefined bookmark identification symbol 425 was drawn. The identified temporal position in the audio data is then stored by the smart pen 100 as an audio bookmark, allowing the user to directly access the temporal position in the audio data corresponding to the time when the predefined bookmark identification symbol 425 was drawn by interacting with the audio bookmark. In an embodiment, the user can specify one or more predefined bookmark identification symbols 425 that cause generation of an audio bookmark by the smart pen 100.

The audio bookmark may be generated at any time the audio data is accessed. For example, an audio bookmark may be identified when the audio data is captured by the microphones 220 or may be generated when previously captured audio is played back. If the audio bookmark is identified during audio data capture, the audio bookmark identifies the position in the audio data where the predefined bookmark identification symbol 425 is received by the smart pen 100. If the audio bookmark is identified during playback of captured audio, the audio bookmark identifies the temporal position of the audio being played when the predefined bookmark identification symbol 425 is received by the smart pen.

Additionally, the coded paper may include one or more control regions, such as navigation buttons 440 and/or control buttons 450, allowing a user to generate an audio bookmark by interacting with the navigation buttons 440 or control buttons 450. For example, responsive to the smart pen accessing a control region (such as a pre-printed button), the smart pen identifies the temporal position in the audio data corresponding to when the control region was accessed. The identified temporal position is then stored by the smart pen 100 to allow direct access to the audio data at the time corresponding to when the control region was accessed.

Alternatively, audio bookmarks can be automatically generated by the smart pen 100 based on one or more predefined or user-defined rules. For example, audio bookmarks can be generated responsive to ink being added to a new page, characteristics of written data (e.g., when notes are indented, when a line is drawn, when a region of the page is used or not used, when page is used for the first time, etc.), changes in the frequency of written data (e.g., when note taking is resumed after being paused for an interval), changes in the received audio data (e.g., after a predetermined interval of silence, when a new speaker is identified, voice pattern analysis, etc.), or receiving an input to pause audio recording. Hence, a position in the audio data corresponding to the fulfillment of one or more of the rules is identified as an audio bookmark. In an embodiment, a user defines the rules used for audio bookmark generation. Additionally, the audio bookmarks can be imported from a source, such as a computing device 120 or an additional smart pen 100, allowing audio bookmarks to be transferred from a first copy of the audio data to a second copy of the audio data.

### Navigation Using Audio Bookmarks

The smart pen 100 may include a display 235, such as an organic light emitting diode (OLED) display which shows a fixed-length position bar 410 to a user. The fixed-length position bar 410 provides a visual indication of the current temporal location within audio data being played back. A first end of the fixed length position bar 410 represents the beginning of the audio data and a second end of the fixed-length position bar 410 represents the end of the audio data. The fixed-length position bar 410 displays the relative length of a session, allowing the fixed-length position bar 410 to represent a session that is a few seconds long or a session that is multiple hours.

The display also superimposes an indicator 420 on the fixed-length position bar 410 to show the current playback position within the audio data. In the example of FIG. 4, the indicator 420 comprises a small polygon or circle represents the current temporal position. In one embodiment, this indicator 420 is visually distinguished from the fixed-length position bar 410, such as by being a different color than the fixed-length position bar 410. The indicator 420 changes position along the fixed-length position bar 410 as the current temporal playback position changes. When audio is playing, the indicator 420 moves from the first end of the fixed-length position bar 410 to the second end of the fixed-length position bar 410. The rate at which the indicator 420 traverses the fixed-length position bar 410 depends on the total length of the audio data because the position bar remains the same length for different lengths of audio data (e.g., in shorter time intervals of audio data the indicator 420 moves faster). If the current playback position is changed, such as by user input to move to a specific location in the audio data, the indicator 420 changes position along the fixed-length position bar 410 to represent the new playback temporal position.

The fixed-length position bar 410 includes one or more bookmark markers 430, indicating the location of an audio bookmark in the audio data, represented in FIG. 4 as lines perpendicular to the fixed-length position bar 410. The bookmark markers 430 show the relative positions of bookmarks to the overall length of the currently played audio data. Alternatively, the smart pen 100 generates an auditory marker, such as a specific tone or noise, when the audio data played corresponds to a bookmark, allowing identification of bookmark location by hearing the auditory marker.

In one embodiment, a printed representation of the fixed-length position bar 415 is included on, or affixed to, the writing surface 50 at one or more locations. Alternatively, the printed representation of the fixed-length position bar 415 is separate from the writing surface 50, such as a part of a card including printed controls or a sticker affixed to a separate object, allowing a printed representation of the fixed-length position bar 415 to be used for navigation through audio data even when the writing surface 50 does not include a printed representation of the fixed-length position bar 415. Similar to the fixed-length position bar 410 shown on the display 235, the printed representation of the fixed-length position bar 415 has a fixed length, and positions along the printed representation of the fixed-length position bar 415 represent relative temporal positions within the currently played audio data. Tapping a region on the printed representation of the fixed-length position bar 415 with the smart pen 100 begins playback of the audio data from the temporal position corresponding to the region that was tapped.

Additionally, the writing surface 50 may also include one or more navigation buttons 440, which allow a user to access different temporal portions of the audio data. Accessing the navigation buttons 440 with the smart pen 100 causes the audio playback to jump to a temporal position associated with an audio bookmark. For example, accessing a first navigation button 440 causes the audio data associated with the next consecutive audio bookmark to be played and accessing a second navigation button causes the audio data associated with the prior consecutive audio bookmark to be played.

To simplify navigation to earlier audio bookmarks, when the second navigation button is accessed, a temporal position in the audio data is played back beginning from a point slightly before the prior consecutive bookmark. For example, if an audio bookmark identifies a temporal position one minute from the beginning of the audio data, accessing the second navigation button begins replay of the audio data from a time slightly before the audio bookmark, such as 58 seconds from the beginning of the audio data, allowing repeated interactions with the second navigation button to navigate backwards through the audio data. In one embodiment, when the smart pen accesses a scan navigation button 440, the smart pen 100 automatically proceeds through a plurality of audio bookmarks and plays a portion of the audio data associated with each audio bookmark, allowing the user to briefly listen to a portion of each audio bookmark. Additionally, the smart pen 100 can be configured so that accessing a predefined bookmark identification symbol 425 causes replay of audio data associated with the corresponding audio bookmark.

In alternative embodiments, different navigation controls may be used to navigation between audio bookmarks. For example, items in a menu may be accessed to navigate between bookmarks. A control mechanism included on the smart pen 100 may also be used for audio bookmark navigation, so that a first input to the control mechanism accesses a next audio bookmark and a second input to the control mechanism accesses a prior audio bookmark. Alternatively, gestures captured by the smart pen 100 cause navigation between audio bookmarks. For example, moving the smart pen 100 upwards or to the left accesses the previous audio bookmark while moving the smart pen 100 down or to the right accesses the next audio bookmark.

Additionally, one or more sheets of the writing surface 50, such as dot-enabled paper, may include control buttons 450 printed at, or affixed to, a location on the writing surface 50. Accessing a control button 450 on any sheet of the writing surface 50 causes the smart pen 100 to take a predetermined action associated with the accessed control button 450. For example, accessing a record control button 450 on any sheet of the writing surface 50 causes the smart pen 100 to begin recording audio. Similarly, accessing a pause control button 450 on any sheet of the writing surface 50 causes the smart pen 100 to pause audio recording. The control buttons 450 offer several advantages, such as: allowing access to controls from anywhere during playback, allowing audio control even if the portion of the writing surface 50, such as a page of the dot-enabled paper, including the original notes is not present, allowing addition of notes to any sheet of the writing surface 50 rather than sheets of the writing surface 50 in sequence with the sheet of the writing surface 50 including the beginning of the notes and creation of multiple sessions from a single sheet of the writing surface 50 and navigation of the multiple sessions using the control buttons 450 included on the single sheet of the writing surface 50.

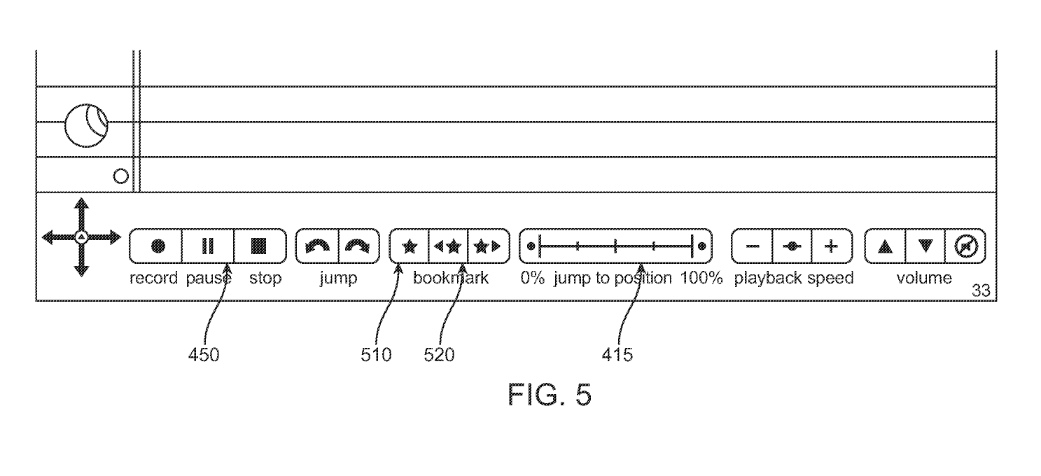

Referring to FIG. 5, another example of the printed representation of the printed representation of the fixed-length position bar 415, one or more navigation buttons 440 and one or more control buttons 450 included on the writing surface 50 is shown. FIG. 5 illustrates a bookmark generation button 510 and bookmark navigation buttons 520. Accessing the bookmark generation button 510 with the smart pen 100 causes generation of an audio bookmark identifying the temporal position in the audio data corresponding to the time when the bookmark generation button 510 was accessed. Accessing the bookmark navigation buttons 520 causes audio data associated with the next consecutive audio bookmark, relative to the current temporal position being played, to be played or audio data associated with the prior consecutive audio bookmark, relative to the current temporal position being played, to be played. Also shown in FIG. 5 are example control buttons 450, which start, stop or pause recording of audio data when accessed by the smart pen 100. In an embodiment, when audio bookmarks are identified while audio capture is paused, the identified audio bookmarks identify the temporal position in the audio data corresponding to the time when audio capture was paused. Similarly, audio bookmarks added when replayed audio data is paused identify the temporal position in the audio data corresponding to the time when audio data playback was paused.

Additionally, an interface on a computing system 120 communicating with the smart pen 100 includes one or more navigation buttons allowing access to different portions of the audio data. Accessing the navigation buttons on the computing system 120 causes playback of audio data to jump to a temporal position associated with an audio bookmark. For example, accessing a first navigation button causes the audio data associated with the next consecutive bookmark to be played and accessing a second navigation button causes the audio data associated with the prior consecutive bookmark to be played. In one embodiment, the user can select a scan navigation button, which automatically proceeds through the audio bookmarks and plays a portion of the audio data associated with each audio bookmark, allowing the user to briefly listen to a portion of each audio bookmark. Additionally, the user can access a representation of a predefined bookmark identification symbol 425 presented by the computing system 120 to prompt replay of audio data starting from the temporal location associated with the accessed audio bookmark.

In an alternative embodiment, the user may speak a word or phrase that is captured by the smart pen 100 or the computing system 120 to access the next audio bookmark or previous audio bookmark and cause replay of audio data from the temporal location associated with the corresponding audio bookmark.

### Audio Bookmark Sharing

In an embodiment, the computing system 120 or another device receives audio bookmarks from multiple sources associated with copies of the same audio data, such as lecture notes from multiple students, aggregates the received audio bookmarks and displays or analyzes the aggregated audio bookmarks. For example, the computing system 120 can display all bookmarks associated with audio data, regardless of which user created the audio bookmark, determine and identify which audio bookmarks have been most frequently accessed, display audio bookmarks associated with a specific user or group of users or provide information describing one or more attributes of the aggregated audio bookmarks. The user can then select one or more sets of audio bookmarks received from third parties and access the received audio bookmarks to navigate through the audio data.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A smart pen device for identifying one or more audio bookmarks in audio data comprising:
a processor;
one or more microphones coupled to the processor for capturing audio data;
a gesture capture system coupled to the processor for capturing written data;
an onboard memory coupled to the processor and configured to store the audio data captured by the one or more microphones;
computer program code stored on a memory and configured to be executed by the processor, the computer program code including instructions for:
receiving an input identifying an audio bookmark,
identifying a temporal location in the captured audio data corresponding to a time the input was received,
associating the audio bookmark with the temporal location in the captured audio data, and
storing in the onboard memory an association between the audio bookmark and the temporal location in the captured audio data.

2. The smart pen device of claim 1, wherein receiving the input identifying the audio bookmark comprises:
capturing one or more predetermined audio signals using the one or more microphones.

3. The smart pen device of claim 2, wherein the one or more predefined audio signals comprise a predetermined word or a predetermined phrase.

4. The smart pen device of claim 1, wherein receiving the input identifying the audio bookmark comprises:
capturing a predetermined written symbol using the gesture capture system.

5. The smart pen device of claim 1, wherein receiving the input identifying the audio bookmark comprises:
capturing an interaction with a predefined region using the gesture capture system.

6. The smart pen device of claim 5, wherein the predefined region comprises a control button included on a writing surface.

7. The smart pen device of claim 1, further comprising:
an audio output system coupled to the processor and configured to play stored audio data; and
computer program code stored on the memory and configured to be executed by the processor, the computer program code including instructions for identifying a temporal location in the stored audio data responsive to receiving an input and providing a portion of the stored audio data starting from the identified temporal location to the audio output system.

8. The smart pen device of claim 1, further comprising:
a display system coupled to the processor for displaying a visual representation of the stored audio data including an indicator associated with the audio bookmark showing a relative temporal position of the audio bookmark in the stored audio data.

9. The smart-pen device of claim 1, further comprising:
computer program code stored on the memory and configured to be executed by the processor, the computer program code including instructions for associating written data captured by the gesture capture system with the temporal location in the temporal location in the captured audio data corresponding to the time the input was received.

10. A method for generating one or more audio bookmarks in audio data comprising:
receiving and storing audio data in a smart pen;
receiving, by the smart pen, one or more inputs identifying one or more audio bookmarks while the smart pen accesses audio data;
identifying a temporal location in the audio data corresponding to a time the input identifying an audio bookmark was received by the smart pen; and
storing an association between the audio bookmark and the temporal location in the audio data corresponding to the time the input identifying the audio bookmark was received by the smart pen.

11. The method of claim 10, wherein receiving, by the smart pen, one or more inputs identifying one or more audio bookmarks comprises:
capturing one or more predetermined audio signals using the smart pen.

12. The method of claim 11, wherein the one or more predefined audio signals comprise a predetermined word or a predetermined phrase.

13. The method of claim 10, receiving, by the smart pen, one or more inputs identifying one or more audio bookmarks comprises:
capturing a predetermined written symbol using the smart pen.

14. The method of claim 10, wherein receiving, by the smart pen, one or more inputs identifying one or more audio bookmarks comprises:
capturing an interaction with a predefined region using the gesture capture system.

15. The method of claim 14, wherein the predefined region comprises a control button included on a writing surface.

16. The method of claim 10, further comprising:
displaying a visual representation of the stored audio data;
displaying a visual indicator associated with the audio bookmark in addition to the visual representation showing a relative temporal position of the audio bookmark in the stored audio data.

17. The method of claim 10, wherein receiving, by the smart pen, the input identifying an audio bookmark comprises:
applying one or more rules to the stored audio data.

18. The method of claim 11, wherein the one or more rules evaluate characteristics selected from a group consisting of: a page associated with the written data, an indentation of a portion of the written data, a delimiter character included in the written data, a page region associated with the written data, an interval of silence in the audio data, a topic identifier included in the audio data and a speaker identification included in the audio data.

19. The method of claim 10, further comprising:
displaying a visual representation of the stored audio data including one or more indicators representing one or more audio bookmarks;
responsive to receiving an interaction with an indicator, accessing the audio data at a temporal location associated with the indicator; and
playing the audio data starting from the temporal location associated with the indicator.

20. The method of claim 19, further comprising:
responsive to receiving a navigation input, accessing the audio data at a temporal location associated with an adjacent indicator; and
playing the audio data starting from the temporal location associated with the adjacent indicator.

21. A pen-based computing system for identifying one or more audio bookmarks in audio data comprising:
a smart pen device configured to capture audio data and written data;
computer program code stored on a memory and configured to be executed by a processor coupled to the smart pen device, the computer program code including instructions for receiving an input identifying an audio bookmark, identifying a temporal location in the captured audio data corresponding to a time the input was received and associating the audio bookmark with the temporal location in the captured audio data; and
a storage device coupled to the processor and the smart pen for storing the captured audio data and an association between the audio bookmark and the temporal location in the captured audio data.

22. The pen-based computing system of claim 21 wherein receiving the input identifying the audio bookmark comprises:
applying one or more rules to the stored audio data

23. The pen-based computing system of claim 21, wherein the one or more rules evaluate characteristics selected from a group consisting of: a page associated with the written data, an indentation of a portion of the written data, a delimiter character included in the written data, a page region associated with the written data, an interval of silence in the audio data, a topic identifier included in the audio data and a speaker identification included in the audio data.
